(19) United States
(12) Patent Application Publication
(10) Pub. No.: US 2026/0171894 A1
(43) Pub. Date: Jun. 18, 2026

(54) Solid State Power Adapter

(71) Applicant: Span.IO, Inc., San Francisco, CA (US)

(72) Inventors: Muhammad Roshanali Rajabali, San Jose, CA (US); Arnaldo Mario Arancibia Moreno, San Mateo, CA (US)

(21) Appl. No.: 18/983,248

(22) Filed: Dec. 16, 2024

(51) Int. Cl. H02M 1/00; B60L 55/00; H02J 7/35; H02J 9/06; H02M 5/10; H02M 5/293

(52) U.S. Cl. CPC H02M 1/0083; B60L 55/00; H02J 7/35; H02J 9/062; H02M 5/10; H02M 5/2932; B60L 2210/42; H02J 2105/42

(57) ABSTRACT

A power-adapting device includes an input connector configured to connect to a non-utility-grid alternating current (AC) power device to receive an input voltage that is not referenced to neutral of a nominal utility voltage level. The power-adapting device also includes a first step-down circuit and a second step-down circuit configured to receive the input voltage to output a first AC output and a second AC output at the nominal utility voltage level. The power-adapting device further includes a controller configured to modulate the first step-down circuit and the second step-down circuit to split the input voltage into the first AC output and the second AC output. The power-adapting device further includes a pair of output connectors configured to be connected to site loads to power the residential-voltage level loads using the first AC output and the second AC output.

### TECHNICAL FIELD

The instant disclosure is related to a power adapter, in particular, a solid state power adapter for converting power from a non-utility grid power source into power for residential use.

### BACKGROUND

Traditional transformers are electrical devices used to transfer electrical energy between two or more circuits through electromagnetic induction. Such transformers operate on the principle of electromagnetic induction. They often include primary winding coil connected to the input voltage source, secondary winding coil where the transformed voltage is output, and a core which is often made of iron or another ferromagnetic material.

When an alternating current (AC) voltage is applied to the primary winding coil, it creates a changing magnetic field around the coil. Since the current is alternating, the magnetic field is also continuously changing. The changing magnetic field generated by the primary winding is concentrated in the core. The core acts as a path to efficiently transfer the magnetic flux between the two windings. The changing magnetic field in the core induces an alternating current in the secondary winding through the process of Faraday's Law of Induction. The induced voltage in the secondary winding depends on the turns ratio between the primary and secondary coils.

However, such traditional transformers are bulky, heavy, and costly. These magnetics and coil based transformers are expensive to manufacture and take up a lot of space and are difficult to install. They can weigh up to 90 pounds or more.

### SUMMARY

In some embodiments, the disclosure described herein relates to a power-adapting device, including: an input connector configured to connect to a non-utility-grid alternating current (AC) power device to receive an input voltage that is higher than a nominal utility voltage level; a first step-down circuit configured to receive the input voltage to output a first AC output; a second step-down circuit configured to receive the input voltage to output a second AC output; a controller configured to modulate the first step-down circuit and the second step-down circuit to split the input voltage into the first AC output and the second AC output; and a pair of output connectors configured to be connected to site loads to power one or more residential-voltage level loads using the first AC output and the second AC output.

In some embodiments, the power-adapting device further includes a split capacitor bank including two capacitors configured to divide the input voltage into two halves of the input voltage.

In some embodiments, the power-adapting device further includes a charging circuit including a pair of switches configured to receive the input voltage and charge the split capacitor bank, wherein the controller causes the pair of switches to be turned on and off alternately.

In some embodiments, each of the first step-down circuit or the second step-down circuit includes a pair of switches controlled by the controller, such that the pair of switches are turned on and off alternately.

In some embodiments, the input connector or the pair of output connectors is a connector that follows a National Electrical Manufacturers Association (NEMA) standard.

In some embodiments, the input connector or the pair of output connectors is a connector that follows an International Electrotechnical Commission (IEC) standard.

In some embodiments, the input voltage is 240 Volt (V), and each of the first AC output and the second AC output is 120V.

In some embodiments, the first AC output and the second AC output are split-phase AC outputs that are 180 degrees out of phase with each other.

In some embodiments, the first AC output and the second AC output are split-phase AC outputs that are 120 degrees out of phase with each other.

In some embodiments, the non-utility-grid AC power device is an electrical vehicle including a battery and an inverter configured to invert direct current (DC) power stored in the battery into AC power.

In some embodiments, the non-utility-grid AC power device is a solar panel configured to convert sunlight into direct current (DC) power, and an inverter configured to convert the DC power into AC power.

In some embodiments, the power-adapting device further includes a bypass switch configured to bypass outputs of the power-adapting device when power is available from a utility grid.

In some embodiments, the controller is further configured to: detect a power outage from the utility grid; and responsive to detecting the power outage from the utility grid, provide the first AC output and the second AC output to the one or more residential-voltage level loads.

In some embodiments, the power-adapting device further includes a third output connector configured to output a third AC output that matches the input voltage.

In some embodiments, the power-adapting device further includes an isolated high frequency link between the input connector and the first step-down circuit or the second step-down circuit. The isolated high frequency link is configured to transform the input voltage into a different voltage, which is then received by the first step-down circuit or the second step-down circuit.

In some embodiments, the power-adapting device further includes a printed circuit board (PCB). The first step-down circuit, the second step-down circuit, the controller, and/or the isolate high frequency link are integrated onto the PCB.

In some embodiments, the disclosure described herein relates to a power management unit, including: a first input connector configured to connect to an alternating current (AC) non-utility-grid power device to receive a first input voltage that is not referenced to neutral of a nominal utility voltage level; a first step-down circuit configured to receive the first input voltage to output a first AC output; a second step-down circuit configured to receive the first input voltage to output a second AC output; a controller configured to modulate the first step-down circuit and the second step-down circuit to split the first input voltage into the first AC output and the second AC output; and a pair of output connectors configured to be connected to site loads to power one or more residential-voltage level loads using the first AC output and the second AC output. In some embodiments, the first input voltage is not referenced to the residential home's neutral and is double an amplitude of a single-line voltage provided by utility.

In some embodiments, the power management unit further includes: a second input connector configured to connect to a utility grid to receive a second AC from the utility grid.

In some embodiments, the controller is configured to: detect whether power is available from the utility grid; and responsive to determining that power is available from the utility grid, provide the second AC to the one or more residential-voltage level loads, bypassing the first AC output and the second AC output.

In some embodiments, the controller is configured to: detect whether power is available from the utility grid; and responsive to detecting a power outage from the utility grid, provide the first AC output and the second AC output to the one or more residential-voltage level loads, bypassing the utility grid.

In some embodiments, the disclosure described herein relates to an electric vehicle (EV) adapter, including: a first input connector configured to connect to an EV to receive a first input voltage that is higher than a nominal utility voltage level; a first step-down circuit configured to receive the first input voltage to output a first AC output; a second step-down circuit configured to receive the first input voltage to output a second AC output; a controller configured to modulate the first step-down circuit and the second step-down circuit to split the first input voltage into the first AC output and the second AC output; and a pair of output connectors configured to be connected to site loads to power one or more residential-voltage level loads using the first AC output and the second AC output.

In some embodiments, the EV adapter further includes: a second input connector configured to connect to a utility grid to receive a second AC from the utility grid to charge a battery of the EV. In some embodiments, the EV adapter is or includes an Electric Vehicle Service Equipment (EVSE).

In some embodiments, the controller is configured to: detect whether power is available from the utility grid; and responsive to determining that power is available from the utility grid, cause the battery of the EV to be charged by the second AC from the utility grid; and responsive to detecting a power outage from the utility grid, provide the first AC output and the second AC output to the one or more residential-voltage level loads.

### BRIEF DESCRIPTION OF THE DRAWINGS

FIG. 1A is a diagram illustrating an environment in which a power-adapting device may be implemented in accordance with some embodiments.

FIG. 1B is a diagram illustrating an environment in which a power-adapting device may be implemented in a power management unit that manages power from both a non-utility grid power device and utility grid, in accordance with some embodiments.

FIG. 1C is a diagram illustrating another alternative environment in which a power-adapting device may be implemented in a power management unit that manages power from both a solar inverter and a utility grid, in accordance with some embodiments.

FIG. 1D is a diagram illustrating another alternative environment in which a power-adapting device may be implemented in a power management unit that manages power from both an EV and a utility grid, in accordance with some embodiments.

FIG. 1E is a diagram illustrating another alternative environment in which a power-adapting device may be implemented in a bi-directional EV charger in accordance with some embodiments.

FIG. 1F is a diagram illustrating an alternative environment in which a power adapter may be implemented as a part of an EV or a portable device that can be removably connected to the EV, in accordance with some embodiments.

FIG. 1G is a diagram illustrating an alternative environment 100G in which a power adapter may be implemented as part of a solar inverter or as a portable device that can be removably connected to the EV, in accordance with some embodiments.

FIG. 2A is a block diagram of an adapter, which may correspond to the adapter in FIGS. 1A-1G, in accordance with some embodiments.

FIG. 2B is a block diagram of an adapter with an isolated high frequency link, which may also correspond to the adapter in FIGS. 1A-1G, in accordance with some embodiments.

FIG. 3A illustrates an example circuit of a solid-state power adapter, which corresponds to diagram in FIG. 2A, in accordance with some embodiments.

FIG. 3B illustrates an example circuit of a solid-state power adapter, which corresponds to diagram in FIG. 2B, in accordance with some embodiments.

FIGS. 4A-4D illustrate diagrams of an adapter configured to operate in different modes in accordance with some embodiments.

FIG. 5A is an end user's view of the modular electrical panel, in accordance with some embodiments.

FIG. 5B is a view of the electrical panel with the dead front panel removed and many of the modular dead front panels removed, in accordance with some embodiments.

FIG. 6 is a perspective diagram of the electrical panel with a different arrangement of electrical modules, in accordance with some embodiments.

The figures depict, and the detailed description describes various non-limiting embodiments for purposes of illustration only.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

The embodiments described herein relate to a solid-state power adapter that can replace and outperform conventional neutral forming transformers (NFTs), also referred to as autotransformers. For example, the solid-state power adapter can be used in a residential environment or with distributed energy resources (DERs), similar to NFTs.

Typically, residences receive two alternating current (AC) voltages—line voltages—that are 120 or 180 degrees out of phase with each other. Each of these line voltages is often 120V AC with reference to neutral. These two voltages can be individually used by residential circuits or combined for circuits that require higher voltage, power, or both. The two voltages can be combined to form 240V AC if the phase difference is 180 degrees or 208V AC if the phase difference is 120 degrees.

On the other hand, DERs typically output a single voltage, which is usually 240V AC. An NFT may be used to convert a single 240V output to two line voltages that measure 120V AC with reference to neutral.

A conventional NFT often includes two series-connected inductors. The two inductors consist of two sets of wire windings around a common magnetic core. The midpoint of the two inductors is connected to neutral, while the other two ends are connected to the voltage output from the DER. Each residential line voltage can then be taken from one end of the autotransformer to the midpoint. This results in two line voltages that are half the amplitude of the voltage from the DER, and each output is 180 degrees out of phase with the other. When the power consumed by both outputs is equivalent, the NFT dissipates nearly no power. However, when there is a difference in power consumption between the two outputs, the NFT dissipates power to maintain an equivalent amplitude for both output voltages.

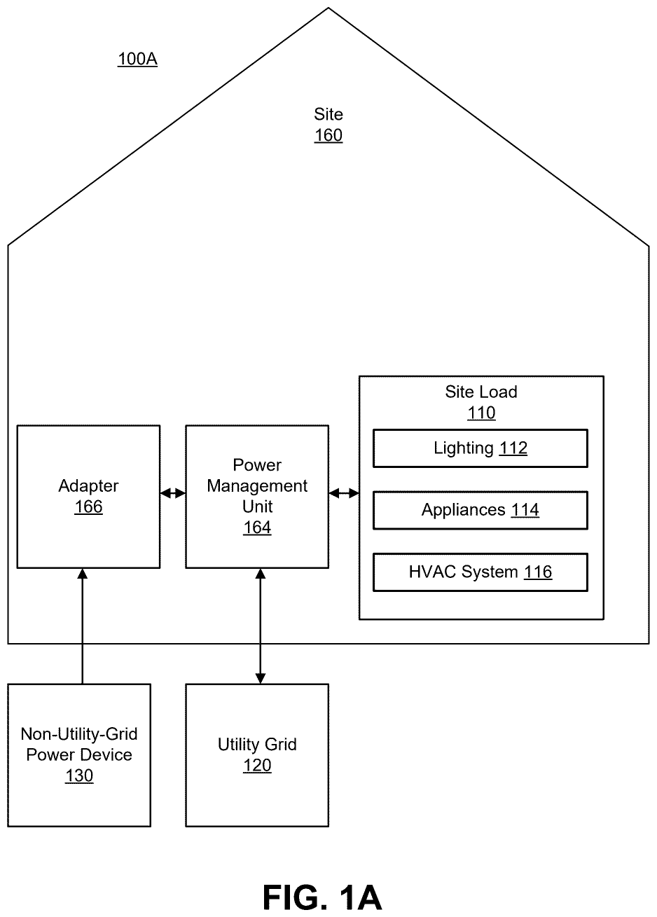

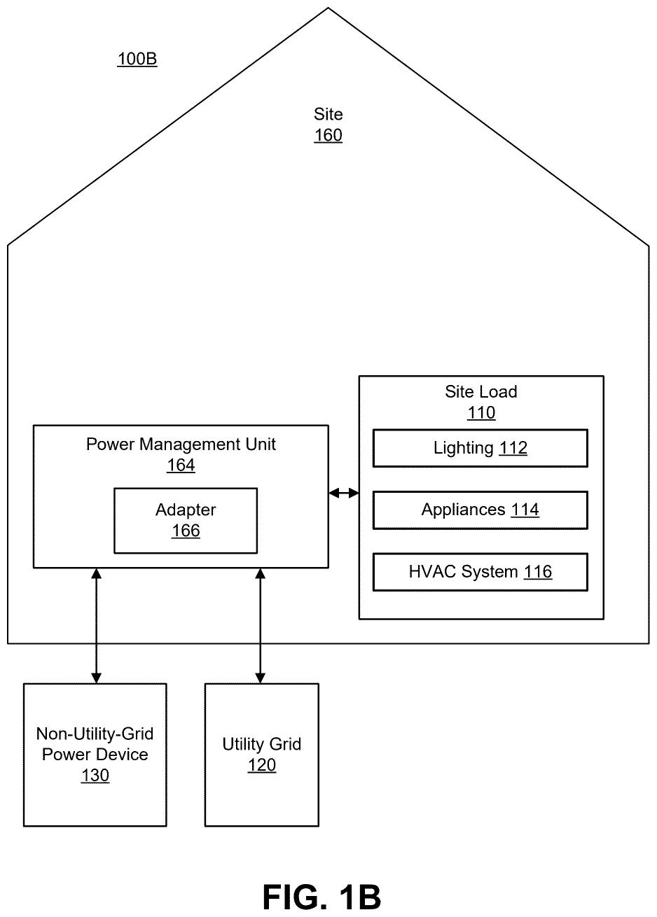

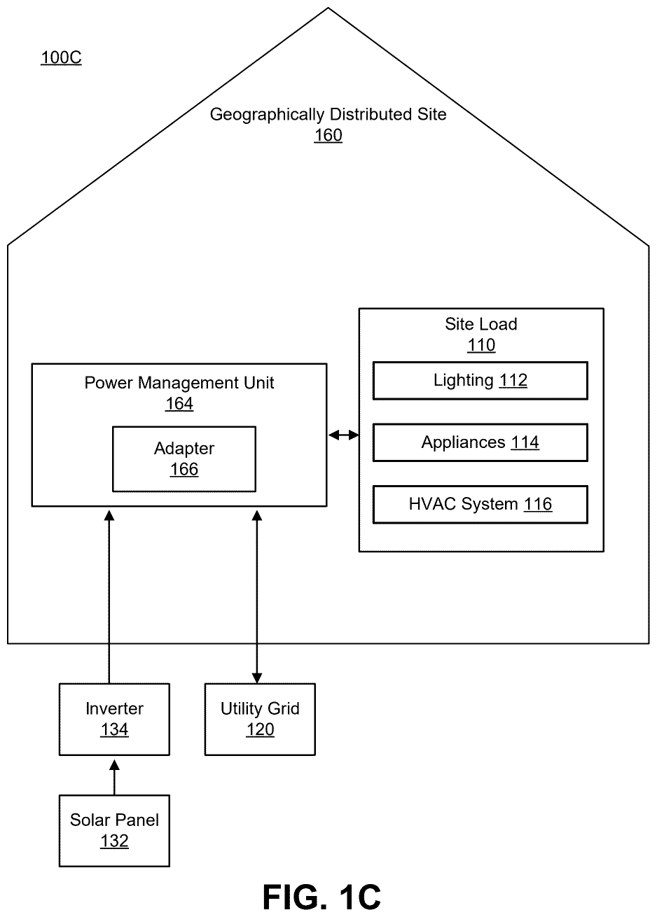

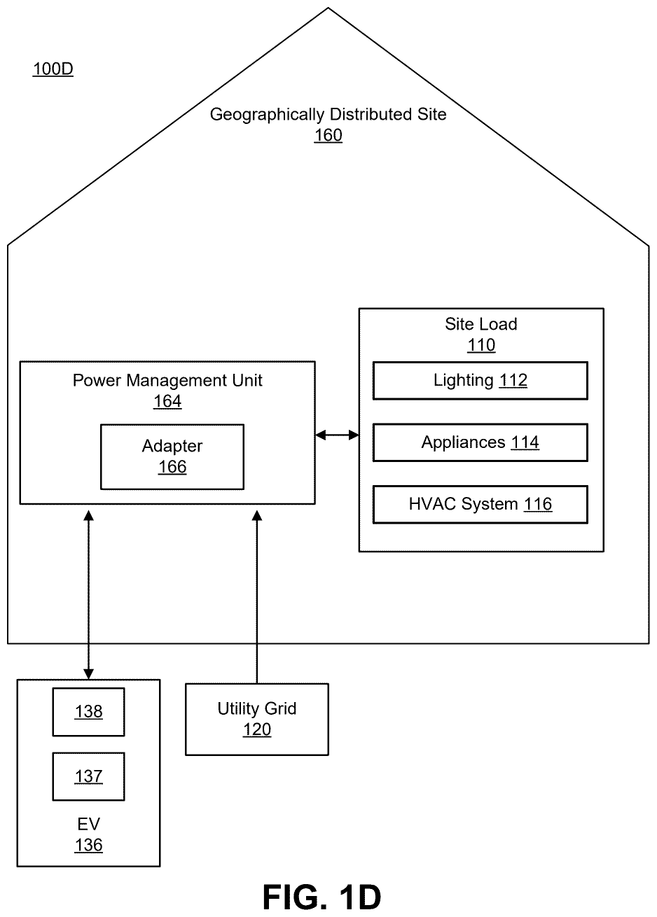

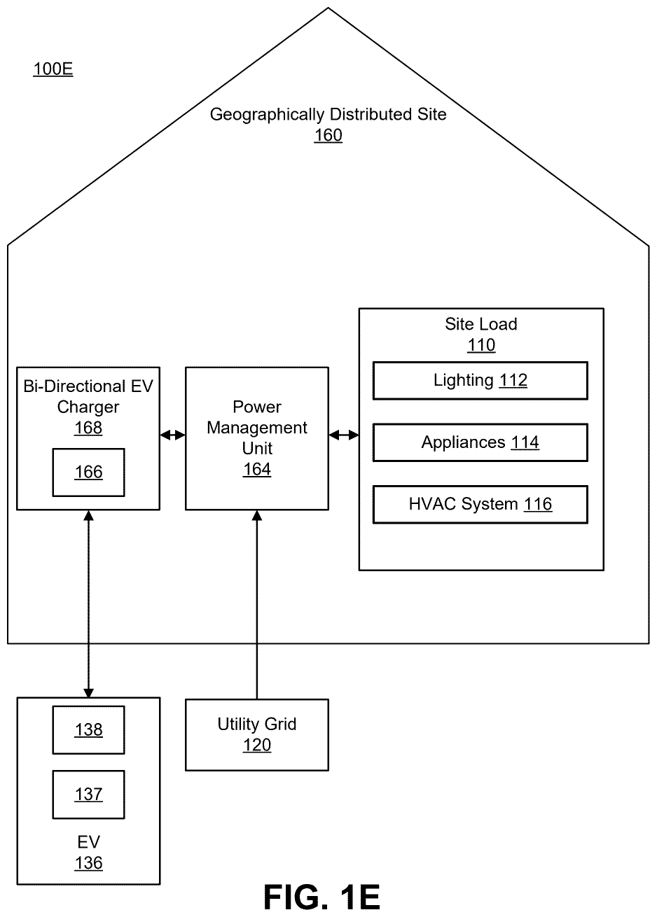

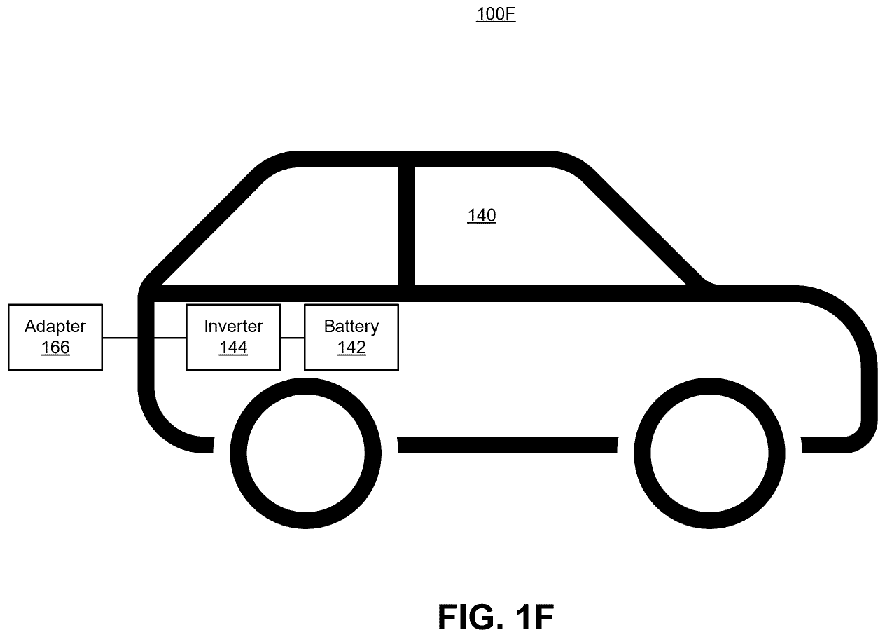

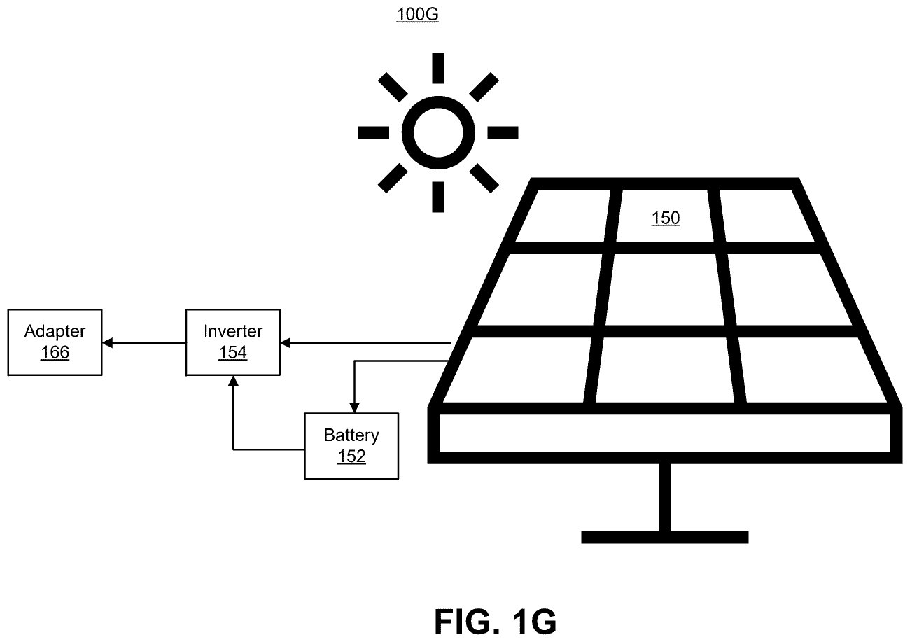

The solid state power adapter described herein addresses the above descripted problem of a conventional NFT. Additional details about the solid state power adapter are further described below with respect to FIGS. 1-6.

### System Overview

FIG. (Figure) 1A is a diagram illustrating an environment 100A in which a power-adapting device may be implemented in accordance with some embodiments. A site 160 may be a residential or commercial site with AC electrical systems used for common appliances, lighting, and other electrical devices. For example, a site 160 may be a residential dwelling unit such as a single family home, a town house, an apartment unit, etc.

In various embodiments, the site 160 is operated at a nominal utility voltage level. Nominal utility voltage levels may vary across the globe, typically ranging from 100V to 240V, reflecting regional standards and historical developments. For instance, Japan utilizes a nominal voltage of 100V, while countries like the United States and Canada predominantly operate at 120V for residential and commercial buildings. Much of Europe, including nations such as Germany, France, and the United Kingdom, standardizes on 230V. Australia also adopts this 230V standard. While the examples in this disclosure will be described primarily using the North America nominal utility voltage level of 120V, various features described in this disclosure may also be used for other voltage levels.

The site 160 includes a utility grid 120, a power management unit 164, and site load 110, including (but not limited to) lighting 112, appliances 114, and/or HVAC system 116. The site 160 also includes a non-utility-grid device 130 that may be configured to operate at a voltage level that is different from the nominal utility voltage level, such as operating at 240V while the nominal utility voltage level being at 120V in North America. A power-adapting device 166 (also referred to as an “adapter,” or “power adapter”) is configured to convert the non-utility voltage level operated at the non-utility-grid device 130 to the nominal utility voltage level, such as by converting a 240 AC power into two 120V split phase AC power. Split-phase AC power is commonly used in residential and light commercial buildings in North America. It provides two 120V AC outputs that are 180 degrees out of phase with each other. When combined, the two 120V AC can supply 240V AC to power higher-voltage appliances.

The utility grid 120 (also referred to as electrical grid or power grid) is a network that delivers electricity from power generation sources to end users, including homes, businesses, and industries. The electricity of the utility grid 120 is generated at large-scale power plants using various energy sources such as fossil fuels (coal, natural gas), nuclear energy, and/or renewable resources (solar, wind, hydroelectric, and/or geothermal). After electricity is generated, it is sent over long distances via high-voltage transmission lines.

Once the high-voltage electricity reaches a distribution substation, it is stepped down to lower voltages suitable for local distribution. The power is further stepped down to levels for residential use. Distribution lines are the lower-voltage lines that carry electricity to homes, businesses, and other buildings to power site load 110.

The voltage provided by a utility grid 120 can vary depending on the country, region, and specific application. In North America, typically, residential utility grid commonly provide 120V split-phase AC, which provides two 120V lines (also referred to as hot wires) and one neutral wire. Each hot wire delivers 120V AC to neutral, allowing for 120V circuits used by most household appliances and outlets. When both hot wires are used together (without neutral), they provide a 240V circuit, which is used for higher-power appliances, such as dryers, ovens, and HVAC.

Site load 110 refers to the electrical power usage of devices, appliances, and systems in a site 160 that consume electricity. These loads may be various devices in a household that require electrical energy to function, ranging from lighting 112 to appliances 114 (e.g., refrigerator, dishwasher, washer, and drier), HVAC systems 116, among others.

In addition to the utility grid 120, there is also one or more non-utility-grid devices 130, which may be an electric vehicle (EV) or a solar panel. The power from these non-utility-grid power devices 130 may operate at a non-utility voltage level (e.g., 240 AC), which is then input into an adapter 166 which converts the power from the non-utility-grid power devices 130 into two or more circuits operating at nominal utility voltage, such as split-phase 120V AC power corresponding to the power supplied by the utility grid 120.

The power management unit (PMU) 164 is a system or device configured to monitor, control, and optimize distribution and consumption of electrical power on the site 160. In the context of a residential or commercial setup, the PMU 164 may be an electrical panel. In some embodiments, the PMU 164 may be a smart electric panel. In some embodiments, the PMU 164 may be integrated with renewable energy systems (e.g., solar panels), EV chargers, and battery storage systems.

In some embodiments, the PMU 164 continuously monitors the power consumption of different devices on site 160. For example, the PMU 164 may be able to track the energy use of appliances 114, HVAC systems 116, lighting 112, and any connected energy storage systems (like EV batteries or solar panels). Real-time data on voltage, current, and energy usage may be collected to provide a complete picture of power consumption patterns. In some embodiments, the PMU 164 may also be able to manage and balance the load, including distributing the available electrical power between various devices to avoid overloading circuits or exceeding the total power supply. In some embodiments, the PMU 164 is configured to ensure that high-priority systems (like HVAC or critical appliances) receive sufficient power, while low-priority devices may have their power supply reduced during peak demand. In systems with non-utility-grid power source (like solar panels, EV batteries), the PMU 164 may also help manage power from these sources as well.

In some embodiments, the PMU 164 is configured to monitor the utility grid 120. Upon detecting that power is not available from the utility grid 120, the PMU 164 bypasses the utility grid and switches to the adapter 166. The adapter 166 is configured to convert power (e.g., 240V AC) from the non-utility-grid device 130 into split-phase 120V outputs, which are then used to at least partially supply power to the site load 110.

FIG. 1B is a diagram illustrating an environment 100B in which a power-adapting device may be implemented in a power management unit that manages power from both a non-utility grid power device and utility grid, in accordance with some embodiments. As shown, the PMU 164 includes a power-adapting device 166. The PMU 164 is configured to receive AC power from both the utility grid 120 and the non-utility-grid device 130. In some embodiments, the utility grid 120 supplies split-phase 120V AC power, and the non-utility-grid device 130 provides 240V AC power. During normal operation, the PMU 164 bypasses the adapter 166 and supplies split phase 120V AC from the utility grid 120 to the site load 110. When a power outage in the utility grid 120 is detected, the PMU 164 switches to the 240V AC output from the non-utility-grid device 130. This 240V AC is then converted into split-phase 120V AC by the adapter 166, which is subsequently supplied to the site load 110.

FIG. 1C is a diagram illustrating another alternative environment 100C in which a power-adapting device may be implemented in a power management unit that manages power from both a solar inverter and a utility grid, in accordance with some embodiments. As shown, the environment 100C includes a solar panel 132 and an inverter 134. The solar panel 132 generates power by converting sunlight into direct current (DC) through the photovoltaic (PV) effect. In some embodiments, the inverter 134 converts the DC power generated by the solar panel 132 into 240V AC power, which is then input to the PMU 164. In some embodiments, a battery (not shown) may be used to store the DC power generated by the solar panel 132, and the inverter 134 is configured to convert the stored power into 240V AC, which is then supplied to the PMU 164. Similarly to FIG. 1B, the PMU 164 includes a power-adapting device 166 configured to convert the 240V AC into a split-phase 120V AC. During normal operation, the PMU 164 bypasses the adapter 166 and supplies split phase 120V AC from the utility grid 120 to the site load 110. When a power outage in the utility grid 120 is detected, the PMU 164 switches to the 240V AC output from the solar panel 132. This 240V AC is then converted into split-phase 120V AC by the adapter 166, which is subsequently supplied to the site load 110.

FIG. 1D is a diagram illustrating another alternative environment 100D in which a power-adapting device may be implemented in a power management unit that manages power from both an EV and a utility grid, in accordance with some embodiments. As shown, the environment 100D includes an EV 136 having a battery 137 and an inverter 138. The inverter 138 is configured to convert DC power stored in the battery 137 into 240V AC power. The PMU 164 receives power from both the utility grid 120 and the inverted 240V AC power from the EV 136. Similarly to FIG. 1B or 1C, the PMU 164 includes a power-adapting device 166 configured to convert the 240V AC into a split-phase 120V AC. During normal operation, the PMU 164 bypasses the adapter 166 and supplies split phase 120V AC from the utility grid 120 to the site load 110. When a power outage in the utility grid 120 is detected, the PMU 164 switches to the 240V AC output from the EV 136. This 240V AC is then converted into split-phase 120V AC by the adapter 166, which is subsequently supplied to the site load 110.

In some embodiments, the PMU 164 also includes an EV charger (not shown). When power is available from the utility grid 120, the PMU 164 enables the EV charger to charge the EV battery 137 of the EV 136. Upon detecting a power outage from the utility grid, the PMU 164 halts the charging operation and switches the EV battery 137 to power supply mode. In this mode, the PMU 164 directs the EV battery 137 to provide power to the inverter 138, which converts the DC power from the EV battery 137 into 240V AC. This 240V AC is then converted into split-phase 120V AC for powering site load 110.

FIG. 1E is a diagram illustrating another alternative environment 100E in which a power-adapting device may be implemented in a bi-directional EV charger in accordance with some embodiments. As shown, environment 100E includes an EV 136 having a battery 137 and an inverter 138 configured to convert DC power stored in the battery 137 into 240V AC power. The bi-directional charger 168 allows electricity to flow in two directions: from the power grid to charge the EV's battery 137, and from the battery 137 back to the charger 168. The bi-directional charger 168 also includes a power-adapting device 166 configured to convert the received 240V AC power from the EV 136 into split-phase 120V AC power, which is then provided to the PMU 164 when needed. Additionally, the bi-directional charger 168 may include a communication interface, enabling it to communicate with the EV 136, the adapter 166, and/or the PMU 164.

During normal operation, the PMU 164 supplies split-phase 120V AC power from the utility grid 120 to the site load 110, including powering the EV charger 168 to charge the EV 136. Upon detecting a power outage, the PMU 164 stops charging the EV 136 and causes the bi-directional charger 168 to switch into a reverse charging mode, allowing the EV 136 to supply 240V AC power to the bi-directional charger 168. The adapter 166 in the bi-directional charger 168 converts the 240V AC power into split-phase 120V AC power, which is then provided to the PMU 164, and subsequently supplied to the site load 110.

FIG. 1F is a diagram illustrating an alternative environment 100F in which a power adapter may be implemented as a part of an EV or a portable device that can be removably connected to the EV, in accordance with some embodiments. As shown, the EV 140 includes a battery 142 and an inverter 144. The battery 142 is configured to store electrical energy in the form of DC. The inverter 144 converts the DC power stored in the battery into 240V AC, which may be used to power a motor that drives the EV 140. In some embodiments, the inverter 144 is coupled to a power adapter 166 configured to receive 240V AC output from the inverter 144 and convert it into split-phase 120V AC, which can then be used to power other devices, such as a laptop, a toaster, a camping stove, etc.

FIG. 1G is a diagram illustrating an alternative environment 100G in which a power adapter may be implemented as part of a solar inverter or as a portable device that can be removably connected to the EV, in accordance with some embodiments. As shown, the solar panel 150 is configured to convert sunlight into DC energy through the photovoltaic effect. The battery 152 receives the DC energy from the solar panel 150 and stores it through a chemical reaction. The inverter 154 is responsible for converting the DC power from the solar panel 150 or the battery into 240V AC. The power adapter 166 is configured to receive the 240V AC from the inverter 154 and convert it into split-phase 120V AC, which can then be used to power other devices, such as a laptop, a toaster, a camping stove, etc.

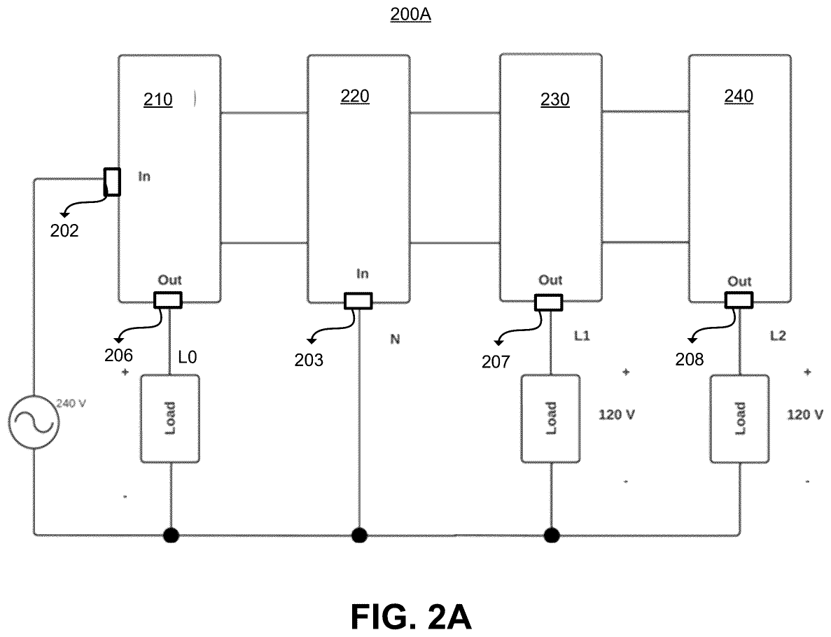

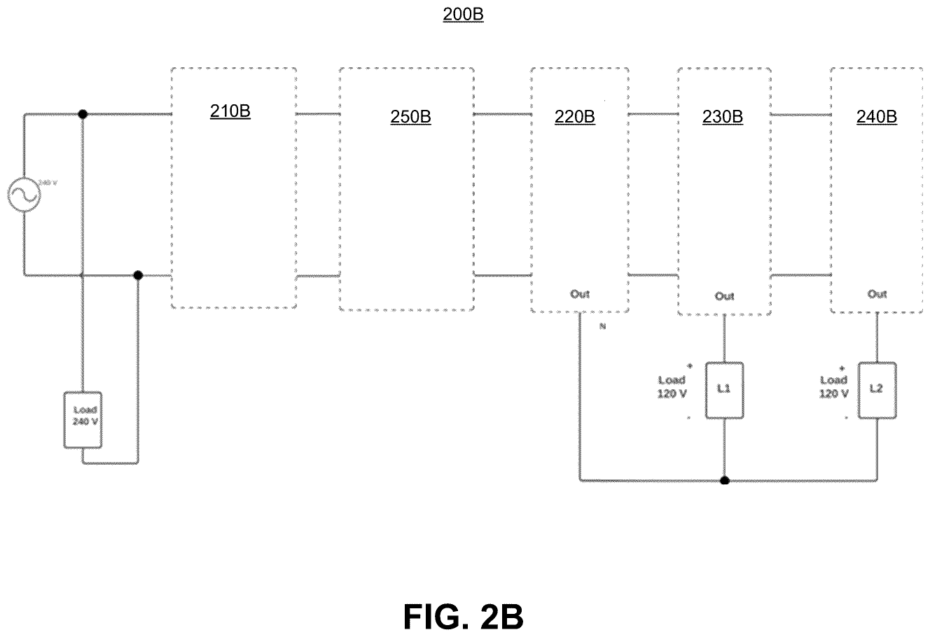

FIG. 2A is a block diagram of an adapter 200A, which corresponds to any one of the adapters 166 illustrated in FIGS. 1A-1G, in accordance with some embodiments. The adapter 200A includes one or more input connectors 202A, 203A, and one or more output connectors 206A-208A. The input connectors 202A, 203A are configured to connect to an AC non-utility grid power device (e.g., an EV or a solar panel inverter) to receive a 240V AC input. The output connectors 207A-208A are configured to output split-phase 120V AC providing power to loads L1 and L2. In some embodiments, the adapter 200A may also include an output connector 206A configured to output a 240A AC output.

An adapter 200A may take different form factors. In some embodiments, an adapter 200A is a handheld adapter 200A. For example, in some embodiments, an adapter 200A may be part of circuitry of a handheld bi-directional EV charger that allows both the changing of the EV from the utility grid and the powering of the site 160 using the battery of EV, such as in situation where the power is down. In some embodiments, the adapter 200 may be part of circuity of a solar inverter that converts solar-generated DC power into AC. In some embodiments, the adapter 200A may be a portable device configured to be connected to a bi-directional EV charger and/or a solar inverter to receive power from the EV and/or the solar inverter.

In these embodiments, adapter 200A, whether as a portable device or integrated with an EV charger, serves as a portable power solution. The adapter 200A can use power from an EV or solar panel to provide temporary electricity during emergencies or outdoor events where the grid is not available, such as camping trip, retreats, food festivals, farmers markets, photoshoots, sports events, music events, among others. For example, the adapter 200 can be used with EVs or portable solar panels to power small appliances like cooking devices, refrigerators, lights, laptops, and/or other essential equipment at these outdoor events.

Alternatively, the adapter 200A may be a part of circuitry of PMU 164 of a site 160, configured to receive power from both utility grid 120 and a non-utility-grid power device 130, such as a bi-directional EV charger or a solar inverter. The PMU 164 can automatically switch from the utility grid to the non-utility power source 130 during power outages or periods of peak demand. In some embodiments, the adapter 200A may be connected to a specific portion of the load. This portion could include high-priority loads such as medical equipment, communication systems, or lighting. During an outage, the PMU 164 automatically switches to the adapter 200A to ensure these high-priority loads are powered. Additionally, the PMU 164 may allow the adapter 200A to supply power to the portion of the load during peak hours to help reduce strain on the grid.

As discussed above, the adapter 200A may be part of an EV charger or configured to connect to an EV charger. Accordingly, in some embodiments, input connectors 202A, 203A of the adapter may include connectors used in EV chargers. These connectors can vary by country and the type of EV. In some embodiments, the input connectors 202A and 203A may include a J plug (also known as a Type 1 connector) that follows the SAE J1772 standard and/or a North American Charging Standard (NACS) connector. J plug and NACS connectors are commonly used in EVs in North America and Japan. In some embodiments, the input connectors 202A and 203A may include a Mennekes (Type 2) connector that follows the IEC 62196-2 standard. Mennekes connectors are often used in EVs in Europe. In some embodiments, the input connectors 202A and 203A may include a GB/T connector, which follows the GB/T 20234.2 standard (for AC charging) and the GB/T 20234.3 standard (for DC charging). GB/T connectors are used in EVs in China. In some embodiments, the adapter 200A may include multiple types of EV connectors, allowing it to connect to different types of EVs.

The output connectors 206A-208A may be other types of connectors configured to connect to one or more loads. In some embodiments, the output connectors 206A-208A may be screw terminals, pin terminals, blade connectors, lug terminals, busbars, and/or DIN rail connectors. In some embodiments, the input and/or output connectors 202-230, 206-208 may be Anderson powerpole connectors. In some embodiments, the input and output connectors 202A-203A, 206A-208A may be connectors that follow National Electrical Manufacturers Association (NEMA) standards, such as NEMA 5-15 plug and socket, NEMA L5-20, NEMA 6-15, or NIMA 6-20. In some embodiments, the connector may be connectors that follow International Electrotechnical Commission (IEC) standards, such as IEC 60320 C13/C14, IEC 60309. In some embodiments, the input and/or output connectors 202A-203A, 206A-208A may also include a locking mechanism, such as twist-lock to prevent accidental disconnection.

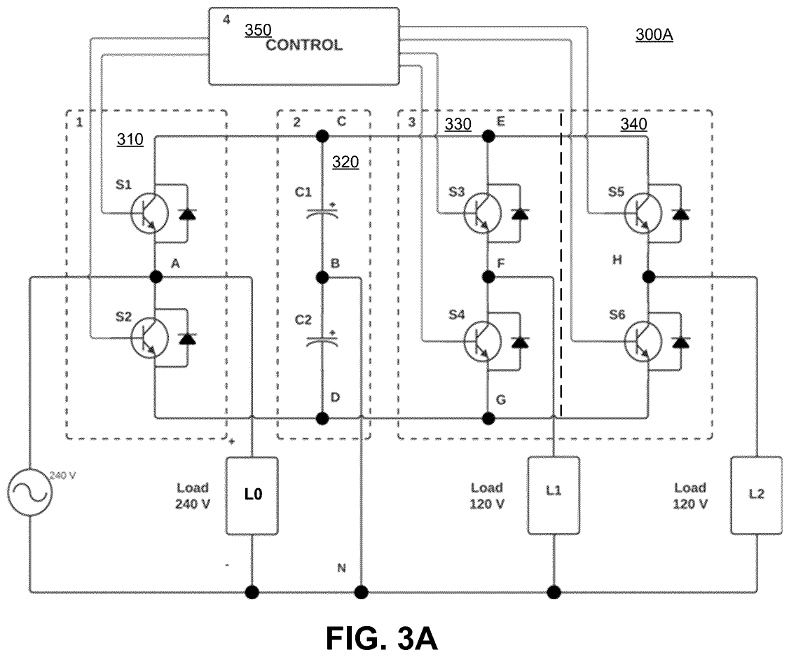

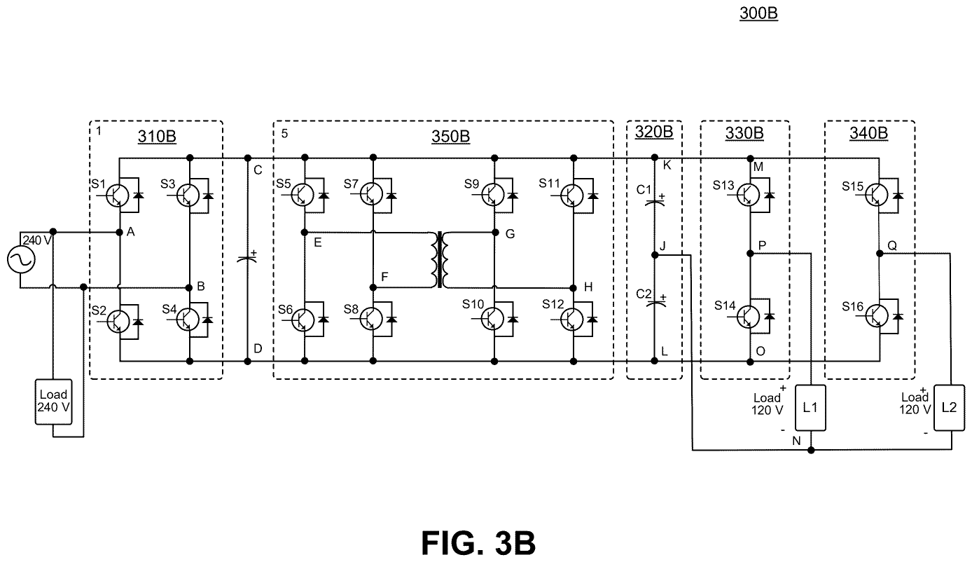

The adapter 200A also includes multiple circuit modules 210A-240A. Module 210A is configured to process the input signal's phase-positive side and provide a modulated voltage to be processed by modules 220A, 230A, and 240A. Module 220A is configured to process the modulated voltage from module 210A and provide a connection to all neutral loads, including the input source of 240V. Module 230A is configured to process the modulated voltage from module 210A and produce 120V in phase (zero phase shift) with the 240V input source. 120V loads can be connected to the output of module 230A. Module 240A is configured to process the modulated voltage from module 210A and produce 120V with a 180-degree phase shift relative to the 240V input source. 120V loads can also be connected to the output of module 240A. The solid-state power adapter 200A may also include a controller (not shown). In some embodiments, the modules 210A, 220A, 230A, 240A, and/or the controller and their interconnections may be implemented on a printed circuit board (PCB) using discrete components and integrated circuits arranged to achieve their respective functionalities. Additional details about these different circuit modules are further described below with respect to FIG. 3A.

In some embodiments, a solid-state power adapter may also include an isolated high frequency link, such as a small transformer that is a discrete component and can be integrated onto a PCB. FIG. 2B a block diagram of an adapter 200B with an isolated high frequency link, in accordance with some embodiments. As illustrated in FIG. 2B, the adapter 200B includes module 210B (which performs a similar function to module 210A in FIG. 2A), module 220B (which performs similar functions to module 220A), module 230B (which performs a similar function to module 230A), module 240B (which performs similar functions to module 240A), and module 250B, which is an isolated high frequency link.

Module 250B is configured to take a input signal at a specific frequency or frequency band (e.g., 50-60 Hz for a power signal) and magnetically (wirelessly) transfer power from a primary coil to an isolated secondary coil. As a result of the magnetic power transfer, the signal on the secondary coil is shifted in phase and may also vary in frequency and amplitude. To address these changes, module 250B may include additional power switches to pre-process and post-process the signal to produce a synchronized output waveform matching the original voltage input. The solid-state power adapter 200B may also include a controller (not shown). Similar to the modules 210A-240A shown in FIG. 2A, the modules 210B-250B, and/or the controller and their interconnections may also be implemented on a PCB using discrete components and integrated circuits arranged to achieve their respective functionalities. Additional details about the circuit modules 250B are further described below with respect to FIG. 3B.

FIG. 3A illustrates an example circuit of a solid-state power adapter 300A, which corresponds to the adapter 200A in FIG. 2A, in accordance with some embodiments. The adapter 300A takes in 240V AC from a non-utility-grid device 130A and outputs both 240V and split-phase 120V AC for powering different loads. The solid-state power adapter 300 includes a charging circuit 310A (which may correspond to module 210A in FIG. 2A), a split capacitor bank 320A (which may correspond to module 220A in FIG. 2A, a first output full-bridge converter 330A (which may correspond to module 230A in FIG. 2A), a second output full-bridge converter 340A (which may correspond to module 240A in FIG. 2A) and a control unit 350A.

The adapter 300 includes multiple switches S1, S2, S3, S4, S5, S6 and two capacitors C1 and C2. Each switch includes a transistor, e.g., MOSFET, which is used to manage the flow of current, and a diode (also referred to as a flyback diode) for protection and current flow control. In particular, the diodes allow current to flow in the opposite direction when the transistor switches off, preventing voltage spikes to protect transistor from damage. The control unit 350A generates control signals to operate each switch, S1-S6. To turn on a switch (S1-S6), the control unit 350A sends a high signal (logical high or gate drive voltage) to the gate of the transistor in the corresponding switch (S1-S6). Conversely, to turn off a switch (S1-S6), the control unit 340 sends a low signal (logical low) to the gate of the transistor in the corresponding switch (S1-S6).

The charging circuit 310A includes switches S1 and S2 configured to receive 240V AC and charge the split capacitor bank 320. The switches S1 and S2 turn on and off by control signals generated by the control unit 340.

The split capacitor bank 320A includes two capacitors C1 and C2 connected in series configured to temporarily store electrical energy delivered by the switches S1 and S2 and split the 240V voltage into two separate halves, i.e., 120V. The midpoint between the two capacitors C1, C2 is a neutral point N.

When S1 turns on, it allows current to flow from the 240 AC input through the circuit towards capacitor C1. Cl charges up during this period, and the voltage across C1 increases. C1 stores electrical energy in the form of an electric field as current flows through it. When S2 is on, it allows current to flow to C2. C2 is charged similarly to C1, and the voltage across C2 builds up, storing energy in the capacitor. Depending on the configuration, switch S2 may allow current to flow in the opposite direction, helping to charge C2 during different portions of the AC cycle.

In some embodiments, S1 and S2 operate in a complementary manner. This means that when S1 is on, S2 is off, and when S2 is on, S1 is off. This complementary switching ensures that current alternates between the two capacitors, charging C1 during one half-cycle of the AC waveform and charging C2 during the other half-cycle. This alternating charging ensures that C1 and C2 get charged during each half of the AC waveform, with one capacitor charging during the positive half-cycle and the other during the negative half-cycle. Capacitors C1 and C2 serve not only as energy storage elements but also help to smooth and stabilize the voltage output.

For example, the control unit 350A may generate and send complementary control signals to switches S1 and S2. This means that when S1 receives a high voltage signal to turn on, S2 receives a low voltage signal to turn off, and vice versa. In some embodiments, the control signal is a pulse-width modulation (PWM) signal, which may be a square wave alternating between a high and low state. The control unit 340 may generate PWM signals in opposite phases, one for controlling switch S1 and the other for controlling switch S2.

The first output full-bridge converter 330A includes switches S3, S4, the second output full-bridge converter 340A includes switches S5, S6. The control unit 350A also generates control signals to control switches S3-S6, causing these switches to split the 240V into two 120V outputs for powering separate 120V loads, L1 and L2. Similar to the control signals for controlling switches S1 and S2, the control unit 340 generates control signals for switches S3-S6, causing each pair of switches (S3/S4 and S5/S6) to work together to generate the two 120V outputs.

In some embodiments, S3 and S4 may also operate in a complementary manner, meaning that when S3 is on, S4 is off, and vice versa. The control unit 340 may generate and send complementary control signals to switches S3 and S4. This means that when S3 receives a high voltage signal to turn on, S4 receives a low voltage signal to turn off, and vice versa. In some embodiments, the control signal is a pulse-width modulation (PWM) signal, which may be a square wave alternating between a high and low state. The control unit 340 may generate PWM signals in opposite phases, one for controlling switch S3 and the other for controlling switch S4. When S3 is on, current flows in a first direction, contributing to the formation of a positive half-cycle for a first 120V AC output; when S4 is on, the current flows in the opposite direction, forming a negative half-cycle for the first 120V AC output.

Similarly, the control unit 340 may generate control signals to cause S5 and S6 to operate in a complementary manner, meaning that when S5 is on, S6 is off, and vice versa. The switches S3/S4 and S5/S6 alternately switch on and off in response to control signals from the control unit 340. This switching enables the proper distribution of energy, converting the 240V into split-phase 120V output.

FIG. 3B illustrates an example circuit of a solid-state power adapter 300B, which corresponds to the adapter 200B in FIG. 2B, in accordance with some embodiments. The solid-state power adapter 300B includes modules 310B (which corresponds to module 210B in FIG. 2B), module 320B (which corresponds to module 220B), module 330B (which corresponds to module 230B), module 340B (which corresponds to module 240B), and module 350B (which corresponds to module 250B). Module 310B generally performs a similar function as module 310A in FIG. 3A, although module 310B includes four switches (which corresponds to an H-bridge), two more than those in module 310A (which corresponds to a half-bridge). The module 320B generally performs a similar function as module 310A, module 330B generally performs a similar function as module 330A, and module 340B generally performs a similar function as module 340A. Thus, modules 310B-340B will not be further described.

However, unlike adapter 300A, adapter 300B further includes an isolated high-frequency link 350B (which corresponds to module 250B in FIG. 2B). As described above with respect to FIG. 2B, the isolated high-frequency link 350B takes a high-frequency input signal and magnetically (wirelessly) transfers power from a primary coil to an isolated secondary coil. As a result of the magnetic power transfer, the signal on the secondary coil may be shifted in phase and may also vary in terms of frequency and amplitude. To address this, module 350B includes power switches S5-S12 to pre-process and post-process the signal to produce a synchronized output waveform matching the original voltage input. The output of module 350B is then supplied to module 320B, which includes a split capacitor bank (explained previously with respect to FIG. 3A). To properly maintain the capacitor's charge with positive or negative voltage magnitudes, the middle joint (J) in the split capacitor bank 320B forms the neutral point or return point of the two output phases, where their respective neutral point (N) is also connected. Modules 330B and 340B shape the load voltage for loads L1 and L2, respectively. To achieve this, load L1 is connected to point P in module 330B, and load L2 is connected to point Q in module 340.

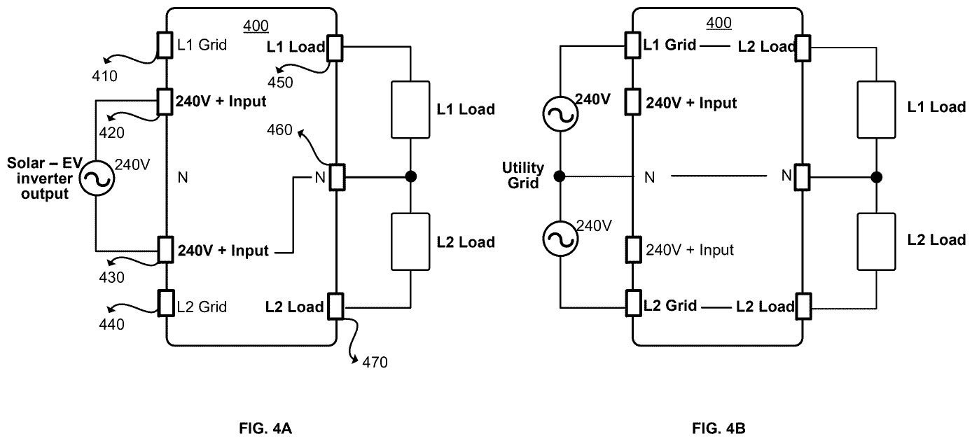

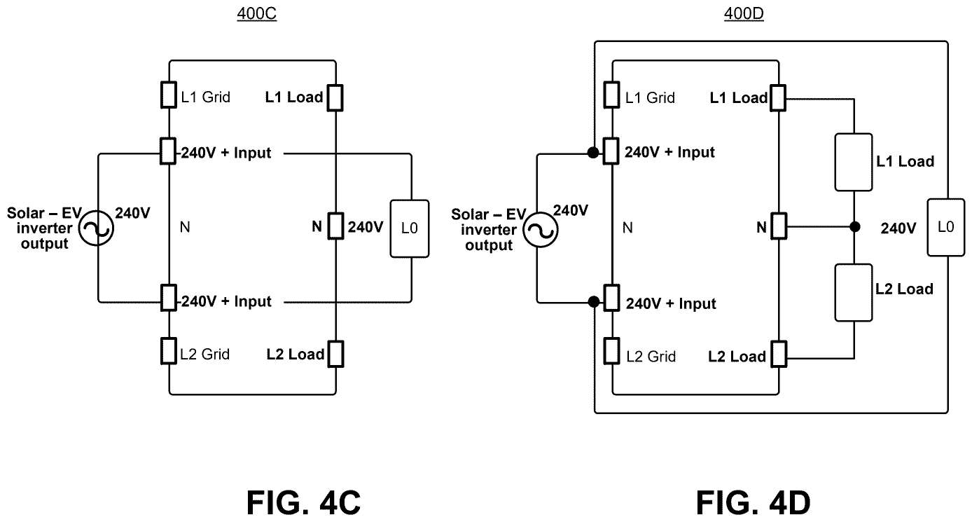

FIGS. 4A-4D illustrate diagrams of an adapter configured to operate in different modes in accordance with some embodiments. In this embodiment, the adapter 400 may be part of a PMU (e.g., PMU 164) that manages power from both a utility grid and a non-utility grid power device, such as an EV or solar panel inverter. The adapter 400 can operate in different modes based on varying conditions. Referring to FIG. 4A, the adapter 400 includes four input terminals 410, 420, 430, 440, and three output terminals 450, 460, 470. Two input terminals, 410 and 440, are configured to receive split-phase 120V AC power from the utility grid. The other two input terminals, 420 and 430, are configured to receive 240V AC power from a non-utility grid power device, such as an EV or solar panel inverter.

The three output terminals, 450, 460, and 470, are configured to output split-phase 120V AC power. Terminal 450 carries one 120V AC, and terminal 470 carries the other 120V AC, which is 180 degrees out of phase with terminal 450. Terminal 460 serves as the neutral terminal between terminals 450 and 470. Terminals 450 and 460 provide 120V AC to a first load L1, while terminals 460 and 470 provide 120V AC to a second load L2.

As shown in FIG. 4A, the adapter 400 operates in non-utility grid split-phase mode. In this mode, the adapter 400 receives a 240V AC input from a solar or EV inverter output, bypassing the utility grid. The 240V AC input is split into two 120V AC outputs, providing power to loads L1 and L2.

Referring to FIG. 4B, the adapter 400 operates in utility grid split-phase mode. In this mode, the adapter 400 delivers split-phase 120V AC to loads L1 and L2, bypassing the non-utility grid power device.

Referring to FIG. 4C, the adapter 400 operates in non-utility grid pass-through mode. In this mode, the adapter 400 passes 240V AC from the non-utility grid power device directly to load L0 without further conversion.

Referring to FIG. 4D, the adapter 400 operates in non-utility grid hybrid mode. In this mode, the adapter 400 outputs both 240V AC and split-phase 120V AC, providing power to loads L0, L1, and L2.

In some embodiments, the operation modes illustrated in FIGS. 4A-4B are controlled by the PMU based on the status of the utility grid and the loads. For instance, under normal conditions, the PMU supplies power from the utility grid to loads L1 and L2, as shown in FIG. 4B. Upon detecting a power outage, the PMU switches to the non-utility grid power device, converting 240V AC to split phase 120V AC to supply loads L1 and L2, as shown in FIG. 4A. In some embodiments, the PMU is also configured to detect the type of load being connected to the adapter 400. For example, upon detecting a load L0 that connects to terminals 420 and 430, the PMU directly passes the 240V AC from the non-utility grid power device, as shown in FIGS. 4C and 4D.

It should be noted that the example embodiments described herein can receive 240V AC from a non-utility-grid power source (e.g., an EV or solar inverter) and output split-phase 120V AC. However, these are only examples. In different geographic regions, site loads may vary, and an inverter may be configured to generate AC at a higher voltage than the local site load. An adapter can then be used to convert this higher voltage AC into a suitable residential voltage, which can be supplied to the site load. For example, in some countries or commercial settings, three-phase power may be available. Three-phase power consists of three outputs with a 120-degree phase difference between them. A three-phase 120V AC system can provide 120V (from phase to neutral) and 208V (between phase-to-phase). Similar principles can be applied to convert higher voltage AC into lower voltage multi-phase AC. For instance, in some embodiments, an adapter may convert 240V AC into three-phase 120V AC.

### Smart Electrical Panel Design

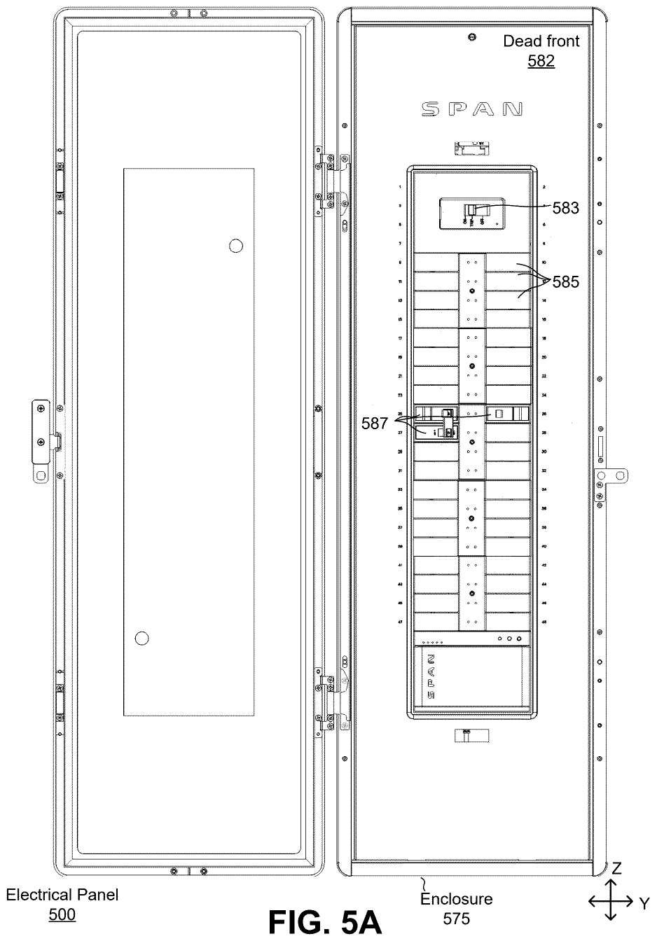

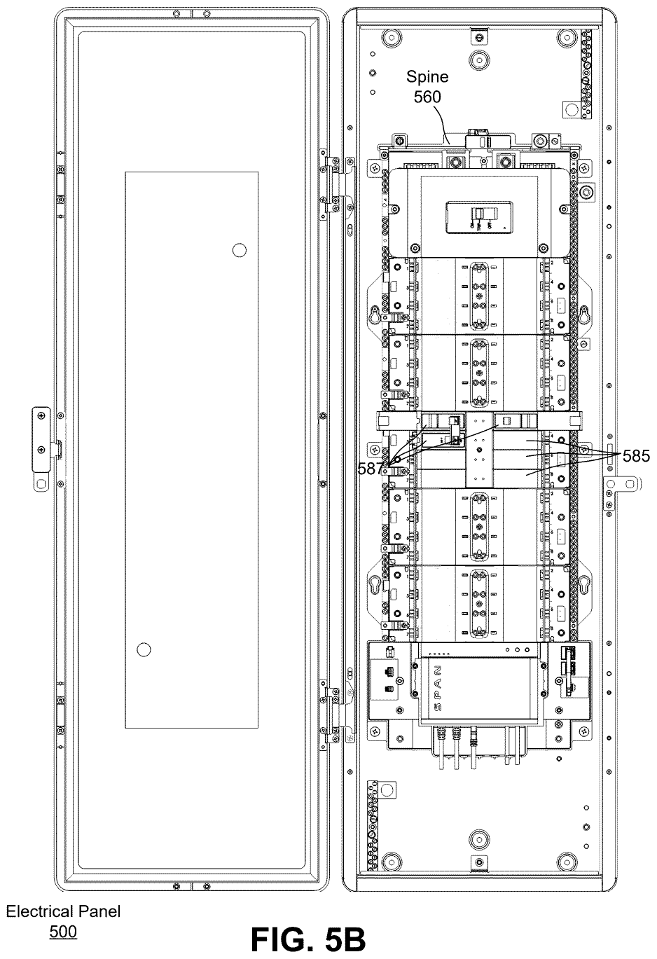

FIGS. 5A and 5B are diagrams illustrating front views of a physical embodiment of a modular electrical panel 500. The modular electrical panel 500 is an example of a PMU 164 that may be used in any geographically distributed sites 160. FIG. 5A is an end user's view of the modular electrical panel 500. In the end-user view, most of the electrical components are not physically accessible because they are hidden in an enclosure 575, under a dead front panel 582, and under modular dead front panels 585 (although the main breaker switch 583 and switches for three overcurrent circuit breakers 587 are accessible). FIG. 5B is a view of the electrical panel 500 with the dead front panel 582 removed and many of the modular dead front panels 585 removed. FIG. 5B illustrates various electrical component modules installed in a spine 560.

Conventional electrical panels on buildings (e.g., residential homes) are bulky, costly, and difficult to install, repair, replace, and upgrade. The modular electrical panel 500 overcomes these limitations with modular electrical components (also referred to as “electrical modules,” “chassis modules,” “modules,” or “electrical panel components” These provide many advantages to installers and building owners: (1) the modular electrical panel can be rightsized for the usage needs of each building. For example, if a building will only use 16 branch circuits, the panel can be installed with just 16 branch circuits (e.g., instead of a larger number of circuits on a conventional preset panel), thus saving the building owner money. Additionally, an installer no longer needs to guess which components will be needed for a given building before arriving at the installation site. (2) The modular electrical components can be installed on many different types of electrical panels (e.g., used in different application settings). (3) The modular electrical components can be mass-produced (since the same set of modules can be installed on many different types of electrical panels). (4) Individual modular electrical components are easily accessible and can be easily replaced on-site without an installer removing large portions of the panel (e.g., without removing adjacent modules). (5) Modular electrical components on an electrical panel can be individually upgraded (e.g., with additional functionalities) without replacing or upgrading the entire electrical panel (or large portions of the panel). Examples of modular electrical panels and modular electrical components that provide one or more of the above advantages are further described below.

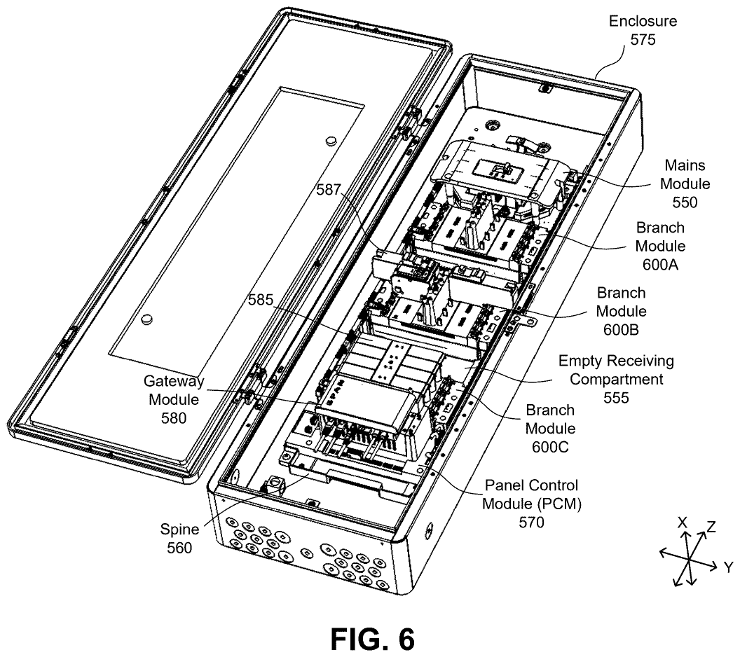

FIG. 6 is a perspective diagram of the electrical panel 500 with a different arrangement of electrical modules. Specifically, in the example of FIG. 6, the panel 500 includes (from top to bottom) a mains module 550, branch modules 600A-B, an empty module receiving compartment 555, a branch module 600C, a panel control module (PCM) 570, and a gateway module 580.

The mains module 550 may include the main breaker of the panel 500, a MID (Microgrid Interconnection Device), or some combination thereof (e.g., no main breaker and no MID). In some embodiments, the mains module 550 includes a main breaker and a MID. The mains module 550 may provide a location to connect the main feeders of the local utility grid 220 to the panel 500, provide overcurrent protection, and/or a disconnect. The mains module 550 may be rated up to 200 amps. If the mains module 550 includes an MID, the MID allows the panel 500 to isolate itself from the grid.

A branch module 600 is a modular electrical panel component that may be installed into one (e.g., of many) of the receiving compartments of the spine 560. Since a building (e.g., a residential building) may include many circuits, a panel may include multiple branch modules 600 to accommodate the expected electrical needs of the building. An example branch module 600 includes eight switched circuit branches (however additional or fewer circuits are possible for a branch module). Each circuit branch includes a stab which can engage with an overcurrent circuit breaker installed on the branch module 600. In some embodiments, the branch module 600 is rated up to 200 amps. The branch module 600 may include additional branch circuit functionalities, such as current or voltage sensing, AFCI protection, light (e.g., LED) indication, or some combination thereof for each circuit branch.

A PCM 570 is a modular electrical component that may be installed in a receiving compartment of the spine 560. The PCM 570 may manage control of the electrical panel 500. For example, the PCM 570 performs computations (e.g., for PowerUp functionalities) and provides power to the other modules on the panel 500. The PCM 570 includes a user interface (UI) display that may give users (e.g., a homeowner) the ability to read the state of the panel 500 and interact with and control the panel 500.

The gateway module 580 is a site controller for a building (e.g., a residential home). If the building includes multiple panels, the gateway module 580 can receive and aggregate data from the multiple panels and determine building-wide control decisions and reports (thus, a building with multiple panels may only use a single gateway module). For example, the gateway module 580 determines decisions for powerup and can send panel reports to a cloud server (pending user permissions). The gateway module 580 may include computer components associated with the above functions, such as a set of processors, a computer-readable medium, and antennas.

In some embodiments, gateway module 580 is also configured to manage power from both a non-utility-grid device 130 and utility grid 120. Gateway module 580 may be configured to continuously monitor power from the utility grid 120. Responsive to determining that the power is out from the utility grid 120, the gateway module 580 automatically switches to an adapter 166, which converts 240V AC from the non-utility-grid device 130 into split-phase 120V AC, which is then provided to the site load 110.

Although the descriptions herein are generally in the context of electrical panel 500, the descriptions herein are generally applicable to chassis that can receive modules and, more specifically, applicable to other types of electrical panels (e.g., the size of the panel and the number of modules may be different) which accommodate different electrical needs for different buildings. In the first example, a smaller panel includes three receiving compartments: a top receiving compartment with a mains module 550, a middle receiving compartment with a branch module 600, and a bottom receiving compartment with a PCM 570. In the second example, a panel includes a top receiving compartment with a lug module, three middle receiving compartments with branch modules 600, and a bottom receiving compartment with a PCM 570.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, or storage medium, as well. The dependencies or references in the attached claims are chosen for formal reasons only.

However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

1. A power-adapting device, comprising:
an input connector configured to connect to a non-utility-grid alternating current (AC) device to receive an input voltage that is not referenced to neutral of a nominal utility voltage level;
a first step-down circuit configured to receive the input voltage to output a first AC output at the nominal utility voltage level;
a second step-down circuit configured to receive the input voltage to output a second AC output at the nominal utility voltage level;
a controller configured to modulate the first step-down circuit and the second step-down circuit to split the input voltage into the first AC output and the second AC output; and
a plurality of output connectors, each configured to be connected to a site load to power the site load at the nominal utility voltage level using one of the AC outputs.

2. The power-adapting device of claim 1, further comprising a split capacitor bank including two capacitors configured to divide the input voltage into two halves of the input voltage.

3. The power-adapting device of claim 2, further comprising a charging circuit including a pair of switches configured to receive the input voltage and charge the split capacitor bank, wherein the controller cause the pair of switches to be turned on and off alternately.

4. The power-adapting device of claim 1, wherein each of the first step-down circuit or the second step-down circuit includes a pair of switches controlled by the controller, such that the pair of switches are turned on and off alternately.

5. The power-adapting device of claim 1, wherein the input connector or a pair of output connectors is a connector that follows a National Electrical Manufacturers Association (NEMA) standard.

6. The power-adapting device of claim 1, wherein the input connector or a pair of output connectors is a connector that follows an International Electrotechnical Commission (IEC) standard.

7. The power-adapting device of claim 1, wherein the input voltage is 240 Volt, and each of the first AC output and the second AC output is 120 Volt.

8. The power-adapting device of claim 7, wherein the first AC output and the second AC output are split-phase AC outputs that are 180 degrees out of phase with each other.

9. The power-adapting device of claim 7, wherein the first AC output and the second AC output are split-phase AC outputs that are 120 degrees out of phase with each other.

10. The power-adapting device of claim 1, wherein the non-utility-grid AC power device is an electrical vehicle including a battery and an inverter configured to invert direct current (DC) power stored in the battery into AC power.

11. The power-adapting device of claim 1, wherein the non-utility-grid AC power device comprises:
a solar panel configured to convert sunlight into direct current (DC) power; and
an inverter configured to convert the DC power into AC power.

12. The power-adapting device of claim 1, further comprising a bypass switch configured to bypass outputs of the power-adapting device when power is available from a utility grid.

13. The power-adapting device of claim 12, wherein the controller is further configured to:
detect a power outage from the utility grid; and
responsive to detecting the power outage from the utility grid, provide the first AC output and the second AC output to one or more residential-voltage level loads.

14. The power-adapting device of claim 1, further comprising a third output connector configured to output a third AC output that matches the input voltage.

15. The power-adapting device of claim 1, further comprising an isolated high frequency link between the input connector and the first step-down circuit or the second step-down circuit, wherein the isolated high frequency link is configured to transform the input voltage into a different voltage, which is then received by the first step-down circuit or the second step-down circuit.

16. The power-adapting device of claim 1, further comprising a printed circuit board (PCB), wherein the first step-down circuit, the second step-down circuit, and the controller are integrated onto the PCB.

17. A power management unit, comprising:
an input connector configured to connect to a non-utility-grid alternating current (AC) power device to receive an input voltage that is not referenced to neutral of a nominal utility voltage level;
a first step-down circuit configured to receive the input voltage to output a first AC output at the nominal utility voltage level;
a second step-down circuit configured to receive the input voltage to output a second AC output at the nominal utility voltage level;
a controller configured to modulate the first step-down circuit and the second step-down circuit to split the first input voltage into the first AC output and the second AC output; and
a pair of output connectors configured to be connected to site loads to power one or more residential-voltage level loads using the first AC output and the second AC output.

18. The power management unit of claim 17, comprising:
a second input connector configured to connect to a utility grid to receive a third AC from the utility grid.

19. The power management unit of claim 18, wherein the controller is configured to:
detect whether power is available from the utility grid; and
responsive to determining that power is available from the utility grid, provide the third AC to the one or more residential-voltage level loads, bypassing the first AC output and the second AC output.

20. An electric vehicle (EV) adapter, comprising:
an input connector configured to connect to a non-utility-grid alternating current (AC) power device to receive an input voltage that is not referenced to neutral of a nominal utility voltage level;
a first step-down circuit configured to receive the input voltage to output a first AC output at the nominal utility voltage level;
a second step-down circuit configured to receive the input voltage to output a second AC output at the nominal utility voltage level;
a controller configured to modulate the first step-down circuit and the second step-down circuit to split the first input voltage into the first AC output and the second AC output; and
a pair of output connectors configured to be connected to site loads to power one or more residential-voltage level loads using the first AC output and the second AC output.
